(19) United States
(12) Patent Application Publication
(10) Pub. No.: US 2012/0103349 A1
(43) Pub. Date: May 3, 2012

(54) Method and Apparatus for Production of Smokeless Tobacco Products

(76) Inventor: Leif Anders Hansson, Malmo (SE)

(21) Appl. No.: 13/284,700

(22) Filed: Oct. 28, 2011

(30) Foreign Application Priority Data
Oct. 29, 2010 (GB) 1018292.1

(51) Int. Cl. A24B 3/08; B05C 5/00; A24B 1/10

(52) U.S. Cl. 131/119; 131/306; 131/111; 118/24

(57) ABSTRACT

Methods of processing tobacco for the production of an oral tobacco product and apparatuses for carrying out such methods are disclosed. In one embodiment, the method comprises transporting tobacco though a duct of a tobacco processing machine with a stream of compressed air, introducing liquid mist into the air stream to lubricate the duct walls to prevent the tobacco sticking thereto, and introducing an additive into the air stream to combine with the tobacco as it passes through the duct.

### CLAIM FOR PRIORITY

This application claims priority under 35 U.S.C. §119 to corresponding British Application Serial No. GB 1018292.1, filed Oct. 29, 2010. The entire contents of the aforementioned application is herein expressly incorporated by reference.

### FIELD

The present disclosure relates to methods and apparatuses for the production of smokeless tobacco products, particularly production of snus pouches.

### BACKGROUND

Various tobacco products are available which are intended for oral administration and do not require combustion. “Smokeless oral tobacco products” are tobacco products which are not intended for combustion but which are instead designed to be placed in the oral cavity of a user for a limited period of time, during which there is contact between the user's saliva and the product.

Snus is a moist smokeless oral tobacco product which is provided in loose form or in individually-wrapped pouches and the tobacco may include additives and/or flavoring agents. In production of snus pouches, a metered plug of loose tobacco is fed under air pressure through a tube into the pouch.

### BRIEF DESCRIPTION OF THE FIGURES

Non-limiting embodiments will now be described, by way of example only, with reference to FIGS. 2-4 of the accompanying drawings, in which:

FIG. 1 shows a schematic view of a conventional snus processing apparatus;

FIG. 2 shows a schematic view of an exemplary snus processing apparatus according to one embodiment;

FIG. 3 shows a schematic view of a lubrication system of the apparatus of FIG. 2; and

FIG. 4 shows a schematic view of an alternative snus processing apparatus according to another embodiment.

### DETAILED DESCRIPTION

Embodiments of the present disclosure provide enhanced methods of producing smokeless tobacco products, such as snus.

Tobacco products such as snus may have a moisture content in the range of 30-60%, and in the production of snus, and particularly loose snus, this relatively high moisture content can result in build-up of deposits on surfaces of machinery used to process snus. The problems associated with such deposits may increase with the moisture content. Such deposits may be especially problematic on the inner surfaces of the pipe-work and ducts through which the snus is transported just prior to being packed into pouches, as particles of snus can become detached from the plug and adhere to the surface of the feed pipe. This can cause inconsistent pouch weights and also ‘spotting’ in the end welds that close the pouch, resulting from tobacco particles that have become detached from the plug being trapped in the welded seam. Typically, to maintain quality standards and to minimise the effect of above problems, production may be halted at regular intervals for the equipment to be cleaned, for example, every 5-20 minutes of production time.

Conventionally, during the manufacturing of snus pouches with a variety of different flavors and/or additives, the additives and/or flavorants are added to loose snus tobacco which is then stored in containers until it is to be filled into individual snus pouches in a later separate manufacturing process. This may result in there being a large number of containers of different loose snus tobacco for the different snus mixtures and flavors, which can require a large amount of storage space and complex, resource intensive monitoring and tracking procedures for the different containers. Furthermore, a certain amount of snus tobacco may be lost or unusable due to the volume of different varieties of the moist snus tobacco needing to be stored and consequently the increased occurrence of some deteriorating during storage and becoming unusable.

In addition, extensive cleaning of the snus pouch filling machinery is typically needed when the processing is switched from one variety of snus tobacco to another, in order to prevent contamination of the latter variety with the former.

Embodiments of the present disclosure provide methods of producing smokeless tobacco products, such as snus, which may increase production capacity, reduce waste, decrease production downtime, decrease required maintenance time, decrease required cleaning, and/or lower associated production costs.

Some embodiments provide a method of processing tobacco for the production of an oral tobacco product, comprising transporting tobacco though a duct of a tobacco processing machine with a stream of compressed air, introducing liquid mist into the air stream to lubricate the duct walls to prevent the tobacco sticking thereto, and introducing one or more additives (“additive”) into the air stream to combine with the tobacco as it passes through the duct.

In one embodiment, the lubricating liquid mist comprises the additive, although in an alternative embodiment, the additive may be introduced into the airflow separately to the lubricating liquid mist. The lubricating liquid mist may comprise water and/or like suitable liquid.

The liquid mist and/or the additive may be introduced into the air steam at a point in the duct upstream of a point at which the tobacco is provided into the duct.

The liquid mist and/or the additive is preferably introduced into the airstream within the duct through at least one nozzle.

In some embodiments the tobacco may be pre-formed into a plug and positioned in the duct to be transported therethrough as the formed plug.

In some implementations, the liquid mist and/or the additive may be introduced into the airstream in intermittent pulses, and the intermittent pulses of liquid mist and/or additive may be coordinated in time with portions of tobacco being provided into the duct to be transported therethrough.

A controller may be coupled to a first dispenser or other means for providing tobacco portions into the duct and to a second dispenser or other means for introducing liquid mist and/or additive into the duct, and the controller may control the second dispenser (or other means) to coordinate the intermittent pulses of liquid mist and/or additive with when the portions of tobacco are provided into the duct.

As an alternative to intermittent pulses, in some embodiments the liquid mist and/or the additive may be introduced into the airstream as a constant flow thereof.

In some implementations, the tobacco initially transported through the duct of the tobacco processing machine is a base blend of tobacco which is unflavored and/or comprises no additives.

The present disclosure also provides an apparatus for processing tobacco for production of an oral tobacco product, comprising a hopper to contain loose tobacco to be processed, a guide duct connected to the hopper into which tobacco from the hopper can be provided, a source of compressed air connected to the guide duct via a supply pipe to provide a compressed airstream to the guide duct to transport tobacco therethrough, and a lubricator or other lubrication system configured to introduce a liquid mist into the airstream to lubricate the walls of the guide duct to prevent tobacco adhering thereto as it is transported through the guide duct, and a dispenser or other additive means to introduce a liquid additive into the compressed airstream to be absorbed by the tobacco.

In one embodiment, the apparatus comprises a tobacco dispenser or other delivery means configured to deliver tobacco from the hopper into the duct to be transported therethrough.

The tobacco dispenser or other tobacco delivery means may comprise a plug-former or other plug-forming means configured to form a plug of a metered amount of tobacco and deliver the metered plug into the duct.

In some embodiments, the lubricator or lubrication system is provided upstream of the tobacco dispenser or delivery means relative to the direction of compressed airstream, and the lubrication system may be disposed in the compressed air supply pipe.

In some implementations, the lubrication system may comprise a spray nozzle coupled to a liquid reservoir configured to introduce liquid mist into the compressed airflow.

In one embodiment, the lubrication system includes a dispenser or other additive means such that the liquid lubricant mist introduced into the compressed airstream comprises additive.

In an alternative embodiment, the apparatus further comprises an additive system comprising a second spray nozzle coupled to a reservoir of additive configured to introduce additive into the compressed airstream separately to the liquid mist introduced into the airstream by the lubrication system.

The apparatus may further comprise a controller connected to the tobacco dispenser or other delivery means and to the lubrication system and/or the additive system and which controls the lubrication system and/or the additive system to spray liquid mist and/or additive into the compressed airstream in intermittent pulses in coordination with when the tobacco delivery system provides tobacco into the duct.

Alternatively, the lubrication system and/or the additive system may be configured to spray liquid mist and/or additive into the compressed airstream as a constant flow thereof.

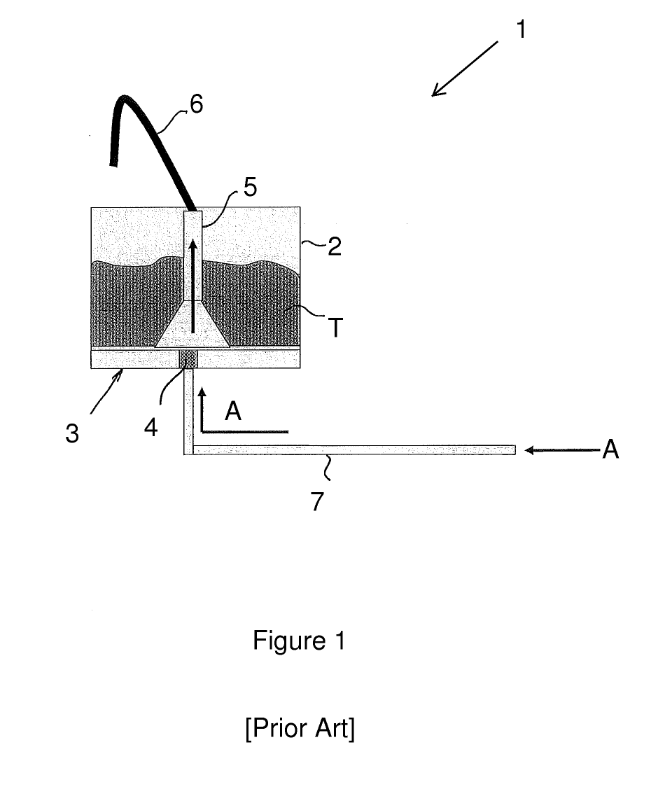

A conventional apparatus 1 for producing snus pouches is shown schematically in FIG. 1 and comprises tobacco hopper 2 to hold loose snus tobacco T, a plug-forming means 3 at the bottom of the hopper 2 to form the loose snus tobacco T into individual metered plugs 4 of snus, and a guide duct 5 for the formed plugs of snus 4 to travel through to a snus dosing pipe 6 connected to the other end of the guide duct 5. In use, the plugs of snus 4 travel through the guide duct 5, through the dosing pipe 6 and into a sleeve of pouch material (not shown) which is then sealed closed between each plug with a weld seam to form individual snus pouch portions.

A pipe 7 is connected to the base of the hopper 2 at the bottom end of the guide duct 5 and is connected to a source of compressed air (not shown) to provide a compressed air flow (shown by arrows ‘A’) though the pipe 7, into the guide duct 5 to propel each plug of snus 4 though the guide duct 5, through the dosing pipe 6 and into the pouch material sleeve.

In the above conventional system, as the plug 4 of tobacco travels through the guide duct 5 and dosing pipe 6, particles of tobacco become detached from the plug 4 and remain adhered to the walls of the guide duct 5, but especially the dosing pipe 6, leading to the cleaning and maintenance issues discussed above. Furthermore, once some particles of tobacco have adhered to the pipe walls, the issues may be further exacerbated, as subsequent snus plugs 4 are fed through the apparatus 1.

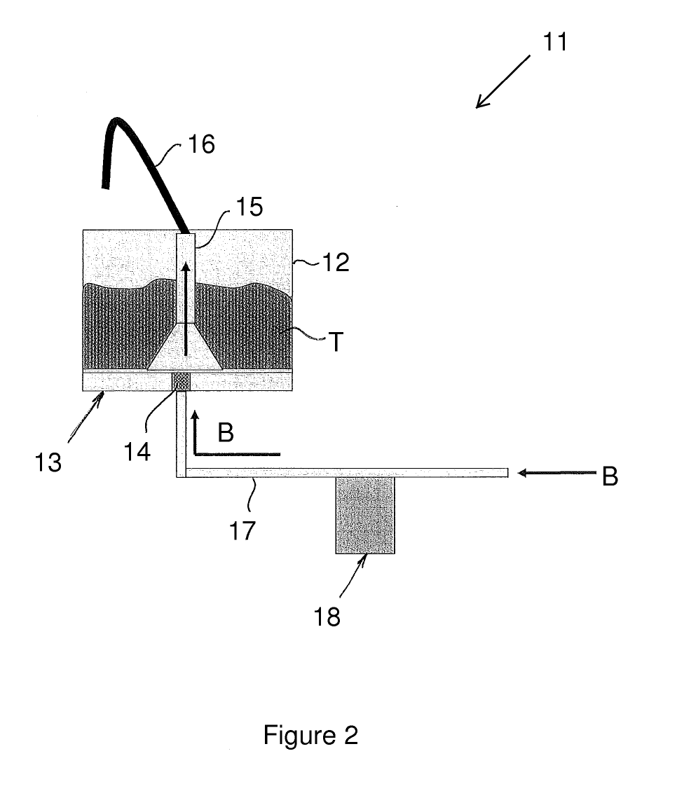

Embodiments of the present disclosure address and overcome such issues, as illustrated by the exemplary apparatus 11 for producing snus pouches according to one embodiment the present disclosure, shown schematically in FIG. 2. The apparatus comprises tobacco hopper 12 to hold loose snus tobacco T, a plug-forming means 13 at the bottom of the hopper 12 to form the loose snus tobacco T into individual metered plugs 14 of snus, and a guide duct 15 for the formed plugs of snus 14 to travel through to a snus dosing pipe 16 connected to the other end of the guide duct 15. A pipe 17 is connected to the base of the hopper 12 and is connected to a source of compressed air (not shown) to provide a compressed air flow (shown by arrows ‘B’) though the pipe 17, into the guide duct 15 to propel each plug of snus 14 though the guide duct 15, through the dosing pipe 16 and into a pouch material sleeve.

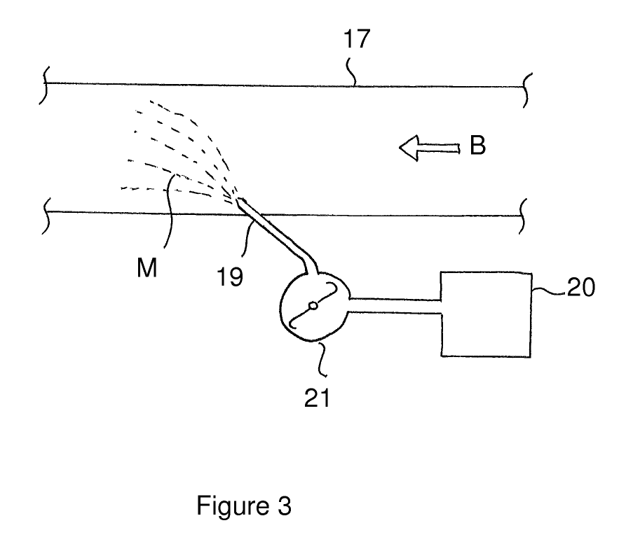

The exemplary apparatus 11 of the present disclosure differs from a conventional apparatus in at least that it includes a lubrication system 18 connected to the air flow pipe 17. An exemplary lubrication system is shown in more detail in FIG. 3, and comprises a spray nozzle 19 coupled to a source of liquid lubricant 20, e.g. water, via a pump 21, the nozzle 19 being configured to spray a mist M of liquid into the compressed air flow B as it travels through the pipe 17. The liquid mist M remains entrained in the air flow B as it travels through the pipe 17 and into the guide duct 15, where the snus plug 14 is delivered and propelled with the compressed air flow through the guide duct 15 and through the dosing pipe 16. The liquid entrained in the compressed air flow provides a lubricant in suspension in the compressed air flow which lubricates the duct/pipe walls and prevents the snus plug 14 from sticking to the pipe/duct walls and so prevents most or any tobacco particles from adhering thereto, thereby alleviating the providing advantages over conventional apparatuses with respect to cleaning, maintenance and other issues as described above.

In some implementations, the lubrication system 18 is configured to spray a pulse of liquid mist M into the compressed air flow at regular intervals during snus pouch production, the intervals being timed to correspond with when a snus plug 14 is delivered to the guide duct 15 by the plug-forming means 13 for feeding to the dosing pipe 16 so that liquid lubricant is provided on the walls of the guide duct 15/dosing pipe 16 just as, or just before, the snus plug 14 is transported therethrough. A controller (not shown) may be connected to the plug-forming means 13 and may control the lubrication system 18 to achieve this co-ordination between the snus plug 14 delivery and spraying of the pulse of liquid into the compressed air pipe 17. In some implementations, such an arrangement may minimize the amount of liquid lubricant the system uses, as the lubrication system 18 is not constantly spraying lubricant into the compressed air flow pipe 17. However, in some embodiments the lubrication system 18 may provide a continuous fine mist into the compressed air flow, which may not require a control system to co-ordinate the pump 21 and nozzle 19 timing to be in register with the snus plug 14 delivery timing, which could reduce apparatus complexity and/or costs.

As discussed above, production of snus pouches having a variety of different blends typically requires storage of a large range of different blends/flavors of snus tobacco, and requires cleaning the production machinery in between each production run of a different tobacco variety to avoid contamination of flavorants/additives between different blends. Conventionally, tobacco with the required additives, such as flavorants, preservatives, balancing agents, etc. already added thereto, would be loaded into the hopper 2 and formed into the snus pouches in the process described above with reference to FIG. 1, and the whole system would be cleaned when a different tobacco blend was to be fed into the hopper 2 to produce a different variety of snus pouch.

Embodiments of the present disclosure provide methods and apparatuses that may alleviate or reduce the above issues. For example, one embodiment provides a process in which, rather than providing the hopper 12 with a large number of different pre-treated loose tobacco blends to create the corresponding number of varieties of snus pouch products, a much smaller number of base tobacco blends without many of the desired additives is fed into the hopper 12. The additives can then be applied to the base tobacco blend as part of the plug-forming and pouch-filling process, as will be described hereafter.

Some implementations, as illustrated by the lubrication system 18 shown in FIG. 3, may be configured to provide the desired additives to the liquid lubricant. For example, the desired mixture of additives, such as flavorants, preservatives, balancing agents, etc., may be provided in the source of liquid lubricant 20, so that the mist M of liquid lubricant sprayed into the compressed air flow pipe 17 contains the additives which are then carried along the air flow pipe 17 entrained in the air stream B, and then are deposited on the snus plug 14 when the air flow meets the snus plug 14 and carries it through the guide duct 15 and dosing pipe 16. Also, the mist M of liquid lubricant sprayed into the compressed air flow pipe 17 which may travel ahead of the snus plug 14 may be deposited on the walls of the guide duct 15 and dosing pipe 16 and so may be absorbed by the snus plug 14 as it travels through the guide duct 15/dosing pipe 16. The additives may also be carried in the compressed air flow to the snus pouch sleeve material so that they are deposited on the pouch as well as absorbed into the snus plug 14. Although this embodiment is discussed as having the additives mixed with the liquid lubricant, in some implementations the solution of additives entirely comprises the liquid lubricant itself and no other additional liquid lubricant may be required.

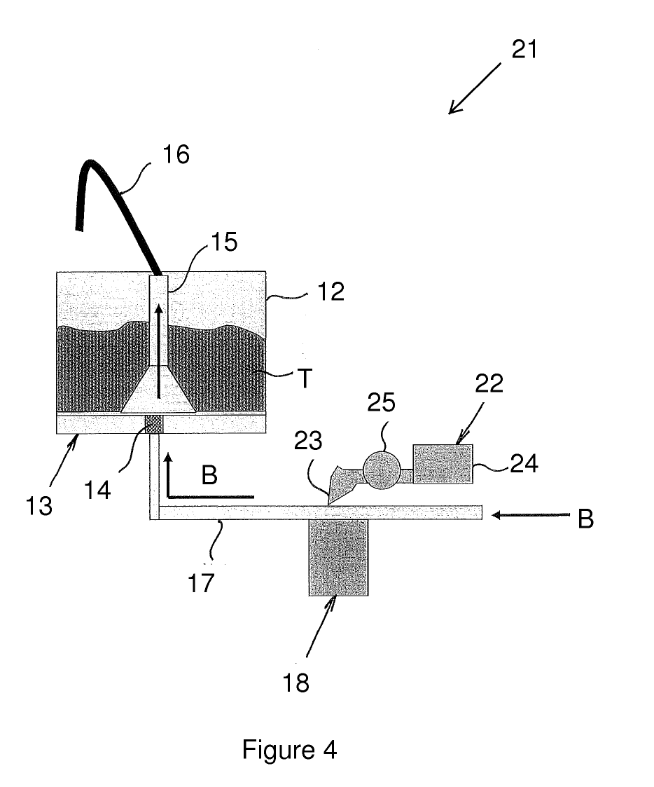

FIG. 4 shows an alternative embodiment 21 comprising a modified version of the apparatus shown in FIGS. 2 and 3, in which like features retain the same reference numerals. Instead of the additives being delivered into the compressed air flow pipe 17 mixed with the liquid lubricant, a separate additive system 22 is provided, comprising a second a spray nozzle 23, coupled to a source of additive 24 via a second pump 25, the second nozzle 23 being configured to spray a mist of the additive into the compressed air flow as it travels through the pipe 17. Here, the system may still include a separate lubrication system 18, so the liquid lubricant and the additives are fed into the compressed air flow B in the pipe 17 separately through separate spray nozzles 19/23. As with the embodiment described in FIG. 2, the liquid entrained in the compressed air flow provides a lubricant in suspension in the compressed air flow which prevents the snus plug 14 from sticking to the pipe/duct walls and so prevents any tobacco particles adhering to the pipe/duct walls, thereby alleviating or reducing the known issues of conventional apparatuses as discussed above. Also, the flavorants/additives carried along the air flow pipe 17 entrained in the air stream may be deposited on the snus plug 14 when the air flow meets the snus plug 14, and those which are deposited on the walls of the guide duct 15/dosing pipe 16 may be absorbed into the snus plug 14. The additives may also be carried in the compressed air flow to the snus pouch sleeve material so that they are deposited on the pouch as well as absorbed into the snus plug 14. Furthermore, the apparatus 21 may be configured to spray a pulse of liquid mist M and/or a pulse of additive into the compressed air flow B at regular intervals during snus pouch production, the intervals being timed to correspond with when a snus plug 14 is delivered to the guide duct 15 by a plug-former or other plug-forming means 13 for feeding to the dosing pipe 16 so that liquid lubricant and additive is provided on the walls of the guide duct 15/dosing pipe 16 just as, or just before, the snus plug 14 is transported therethrough. As described previously, a controller (not shown) may be connected to the plug-forming means 13 and may control the lubrication system 18 and the additive system 22 to achieve this co-ordination between the snus plug 14 delivery and spraying of the pulse of liquid lubricant and liquid additive into the compressed air pipe 17. However, also as discussed above, the apparatus 12 may provide a continuous fine mist of lubricant and/or additive into the compressed air flow, which would remove the need for a control system to co-ordinate the pump(s) 21/25 and nozzles 19/23 timing to be in register with the snus plug 14 delivery timing. Combinations of the above arrangements may also be provided, e.g. a constant mist of lubricant with intermittent timed pulses of additive, or vice versa.

It will be appreciated that the above-described embodiments provide a process of snus pouch production which results in even additive and/or flavor distribution throughout the snus tobacco and the resulting snus pouch, and which avoids the need for frequent cleaning of machinery between different variety of snus production runs, as there is only a small number of base blends which are provided into the hopper 12, potentially only one single base blend of additive-free tobacco.

Furthermore, the lubrication system prevents build up of snus tobacco particles in the guide duct 15 and dosing pipe 16, thereby avoiding the need for frequent stoppages in the production run for the equipment to be cleaned to prevent product quality deteriorating. It has been found that constant production runs of up to 8 hours can be achieved with an apparatus of an embodiment of the invention, compared to a maximum of around 20-30 minutes with conventional processing machinery.

It has been found that a liquid lubricant mist supplied into the duct at a rate of around 4 ml per minute provides good duct/pipe lubrication results although other volume supply rates are intended to fall within the scope of the invention. Also, it has been found that a pulse of around 0.015 ml of liquid lubricant mist per 0.8 g snus plug provides good duct/pipe lubrication results although other volume supply rates are also within the scope of this disclosure.

Although the embodiments shown and described above show the liquid lubricant and/or additive nozzle(s) located upstream of the point at which the snus plug is delivered into the guide duct, it is within the scope of the disclosure that one or both nozzles may be located downstream of this point, so that, for example, the guide duct 15 and dosing pipe 16 are only provided with liquid lubricant and/or additive downstream from the point where the snus plug is provided.

It will be appreciated that the combined solution of the lubrication system and additive system results in a single tobacco processing method and apparatus which is substantially more efficient, simpler and effective than conventional manufacturing processes and so, as a single synergistic process, provides substantial cost benefits over the separate and relatively inefficient conventional processes described above.

In order to address various issues and advance the art, the entirety of this disclosure (including the Cover Page, Title, Headings, Field, Background, Summary, Brief Description of the Drawings, Detailed Description, Claims, Abstract, Figures, and/or otherwise) shows by way of illustration various embodiments in which the claimed invention(s) may be practiced and provide for superior techniques for treating and packaging tobacco products. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and modifications may be made without departing from the scope and/or spirit of the disclosure. As such, all examples, implementations, and/or embodiments are deemed to be non-limiting throughout this disclosure. Also, no inference should be drawn regarding those embodiments discussed herein relative to those not discussed herein other than it is as such for purposes of reducing space and repetition. Various embodiments may suitably comprise, consist of or consist essentially of, various combinations of the disclosed elements, components, features, parts, steps, means, etc. Some of the disclosed features, elements, implementation, etc., may be mutually contradictory, in that they cannot be simultaneously present in a single embodiment. Similarly, some features are applicable to one aspect of the disclosure, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, structural, topological, and/or other aspects of the disclosure are not to be considered limitations on the disclosure as defined by the claims or limitations on equivalents to the claims.

1. A method of processing tobacco for production of an oral tobacco product, comprising:
transporting tobacco though a duct of a tobacco processing machine with a stream of compressed air;
introducing liquid mist into the air stream to lubricate walls of the duct to prevent the tobacco sticking thereto; and
introducing an additive into the air stream to combine with the tobacco as it passes through the duct.

2. The method according to claim 1 where the lubricating liquid mist comprises the additive.

3. The method according to claim 1 wherein the additive is introduced into the air stream separately to the lubricating liquid mist.

4. The method according to claim 1 wherein the lubricating liquid mist comprises water.

5. The method according to claim 1 wherein at least one of the liquid mist and the additive is introduced into the air steam at a point in the duct upstream of a point at which the tobacco is provided into the duct.

6. The method according to claim 1 wherein at least one of the liquid mist and the additive is introduced into the air stream within the duct through at least one nozzle.

7. The method according to claim 1 wherein the tobacco is pre-formed into a plug and positioned in the duct to be transported therethrough as the formed plug.

8. The method according to claim 1 wherein at least one of the liquid mist and the additive is introduced into the air stream in intermittent pulses.

9. The method according to claim 8 wherein the intermittent pulses of at least one of liquid mist and additive are coordinated in time with portions of tobacco being provided into the duct to be transported therethrough.

10. The method according to claim 9 wherein a controller coupled to a tobacco dispenser providing tobacco portions into the duct and to an additive dispenser introducing at least one of liquid mist and additive into the duct controls the additive dispenser to coordinate intermittent pulses of the at least one of the liquid mist and additive with when the portions of tobacco are provided into the duct.

11. The method according to claim 1 wherein the at least one of the liquid mist and the additive is introduced into the airstream as a constant flow thereof.

12. The method according to claim 1 wherein the tobacco initially transported through the duct of the tobacco processing machine is a base blend of tobacco which is unflavored.

13. The method according to claim 1 wherein the tobacco initially transported through the duct of the tobacco processing machine is a base blend of tobacco which comprises no additives.

14. An apparatus for processing tobacco for production of an oral tobacco product, comprising:
a hopper to contain loose tobacco to be processed;
a guide duct connected to the hopper into which tobacco from the hopper is provided;
a compressed air source connected to the guide duct via a supply pipe to provide a compressed airstream to the guide duct to transport tobacco therethrough;
a lubrication system configured to introduce a liquid mist into the air stream to lubricate the walls of the guide duct to prevent tobacco adhering thereto as it is transported through the guide duct; and
an additive dispenser to introduce a liquid additive into the compressed air stream to be absorbed by the tobacco.

15. The apparatus according to claim 14 further comprising a tobacco dispenser configured to deliver tobacco from the hopper into the duct to be transported therethrough.

16. The apparatus according to claim 15 wherein the tobacco dispenser comprises a plug-former configured to form a plug of a metered amount of tobacco and deliver the metered plug into the duct.

17. The apparatus according to claim 15 wherein the lubrication system is provided upstream of the tobacco dispenser relative to the direction of compressed airstream.

18. The apparatus according to claim 17 wherein the lubrication system is disposed in the compressed air supply pipe.

19. The apparatus according to claim 15 wherein the lubrication system comprises a spray nozzle coupled to a liquid reservoir configured to introduce liquid mist into the compressed airflow.

20. The apparatus according to claim 14 wherein the lubrication system includes the additive dispenser such that the liquid lubricant mist introduced into the compressed airstream comprises additive.

21. The apparatus according to claim 19 further comprising an additive system comprising a second spray nozzle coupled to a reservoir of additive configured to introduce additive into the compressed airstream separately to the liquid mist introduced into the airstream by the lubrication system.

22. The apparatus according claim 21, further comprising a controller connected to the tobacco dispenser and to at least one of the lubrication system and the additive system, and configured to control the at least one of the lubrication system and the additive system to spray liquid mist/additive into the compressed airstream in intermittent pulses in coordination with when the tobacco dispenser provides tobacco into the duct.

23. The apparatus according to claim 14, wherein at least one of the lubrication system and the additive dispenser are configured to spray liquid mist/additive into the compressed airstream as a constant flow thereof.
